(19) United States
(12) Patent Application Publication
(10) Pub. No.: US 2022/0221777 A1
(43) Pub. Date: Jul. 14, 2022

(54) Portable Projector with Bluetooth Audio and Mobile Phone Charging Functions

(71) Applicant: Xiaocheng Huang, Shenzhen (CN)

(72) Inventor: Xiaocheng Huang, Shenzhen (CN)

(21) Appl. No.: 17/575,658

(22) Filed: Jan. 14, 2022

(30) Foreign Application Priority Data
Jan. 14, 2021 (CN) 202110049577.1

(51) Int. Cl. G03B 21/14; G03B 21/28; G03B 31/00; G03B 21/16; H04R 1/02; H04R 3/00; G06F 3/16; H04R 1/22

(52) U.S. Cl. CPC G03B 21/142; G03B 21/145; G03B 21/28; G03B 31/00; G03B 21/16; H04R 2430/01; H04R 3/00; G06F 3/165; H04R 1/22; H04R 2499/15; H04R 2420/07; H04R 1/028

(57) ABSTRACT

The disclosure claims a portable projector with Bluetooth audio and mobile phone charging functions, wherein it comprises a case, a lens mounted in the case, a reflector and a circuit board, the left and right sides of the case being semi-elliptical surfaces, the lens being provided inside the case and near the semi-elliptical surface of that side of the case, and the edges of the reflector and circuit board being provided in a rounded shape so that they fit the semi-elliptical surface of the case. In this disclosure, the design that the lens is arranged on one side of the projector makes the operation of tuning the focal length more convenient, and the design that the reflector and the lens are in a conjoined structure is convenient for the lens to lean against the side. The audio mode and the projector mode can be switched with one key by sliding the sliding cover left and right, and the operation is made more portable by voice prompts.

### TECHNICAL FIELD

The disclosure relates to the technical field of projectors, and in particular to a portable projector with Bluetooth audio and mobile phone charging functions.

### BACKGROUND

With the widespread popularity of smart homes, portable projectors for home use are recognized by more and more users, and existing portable projectors on the market are generally designed with the lens located in the middle. When using, to maintain the correct projection angle, the projector needs to be fixedly placed in a certain position, and the design in which the lens is located in the middle is still deficient in terms of portability of operation, so the prior art needs to be improved.

### SUMMARY

In response to the problems in the prior art, the disclosure extends a portable projector with Bluetooth audio and mobile phone charging functions.

For the above purposes, the specific solution in this disclosure is as follows:

A portable projector with Bluetooth audio and mobile phone charging functions, comprising a case, a lens mounted in the case, a reflector and a circuit board, wherein the left and right sides of the case are semi-elliptical surfaces, the lens is provided inside the case and near the semi-elliptical surface of that side of the case, and the edges of the reflector and circuit board are provided in a rounded shape so that they fit the semi-elliptical surface of the case.

Preferably, a sliding cover is provided in front of the lens for controlling on/off of the projector, and the projector prompts the user to turn on the Bluetooth audio mode when the sliding cover is not opened after the projector is electrically connected.

Preferably, an audio assembly is mounted within the semi-elliptical surfaces on both sides of the case.

Preferably, the audio assembly comprises a full-range speaker and a sound chamber, the full-range speaker is mounted in the sound chamber, and an air duct is provided on the inner side wall of the sound chamber to allow air to circulate back and forth between the inside and outside of the sound chamber to achieve high fidelity.

Preferably, the lens is provided with a rotatable tuning ring for rotatably tuning the focal length of the lens.

Preferably, a knob for tuning the volume is provided on the front of the projector, and the knob is provided at a position symmetrical to the lens.

Preferably, the knob side is further provided with a headphone jack, a USB outlet, and a VGA connector, and the USB outlet can be connected to a mobile phone to charge the mobile phone.

Preferably, a heat sink is further provided on the back of the projector.

Preferably, an encoder is provided in front of the heat sink.

Preferably, a toggle is further provided on the back of the projector for tuning the screen square.

Using the technical solution of the disclosure has the following beneficial effects: the design that the lens is arranged on one side of the projector makes the operation of tuning the focal length more convenient, and the design that the reflector and the lens are in a conjoined structure is convenient for the lens to lean against the side. The audio mode and the projector mode can be switched with one key by sliding the sliding cover left and right, and the operation is made more portable by voice prompts.

### BRIEF DESCRIPTION OF DRAWINGS

FIG. 1 is an exploded view of the disclosure;

FIG. 2 is a three-dimensional view of the disclosure;

FIG. 3 is a three-dimensional view of the disclosure in another perspective; and

FIG. 4 is a three-dimensional view of the audio assembly of the disclosure.

### DETAILED DESCRIPTION OF THE PREFERRED EMBODIMENTS

The disclosure will be further described below with reference to the drawings and embodiments.

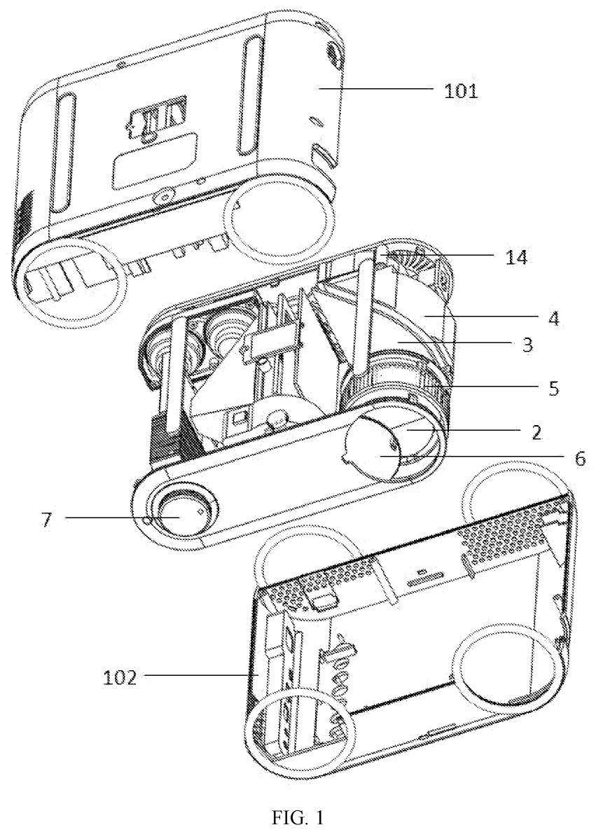

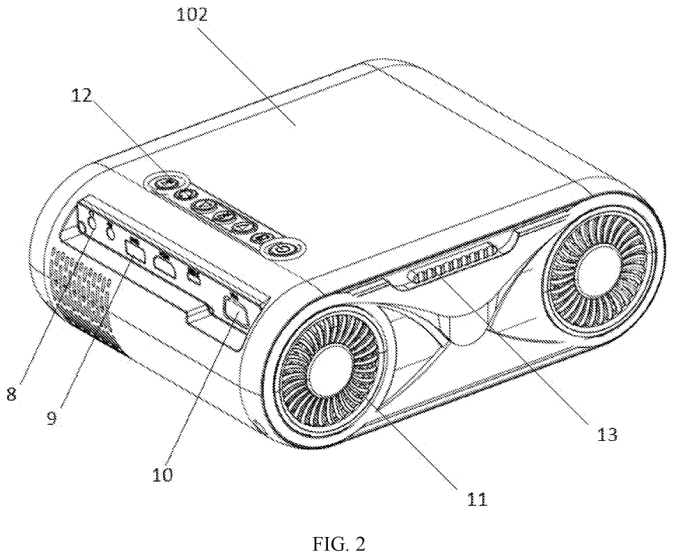

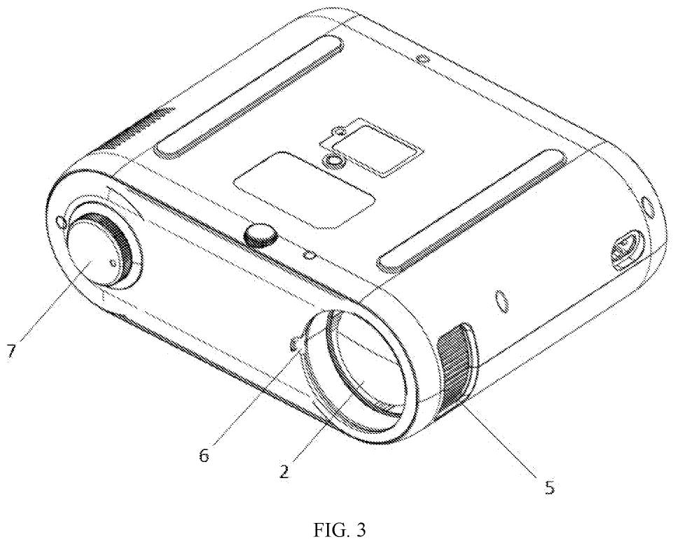

Referring to FIGS. 1 to 3, the disclosure provides a portable projector with Bluetooth audio and mobile phone charging functions, comprising case 101 and case 102, a lens 2 mounted in the case, a reflector 3 and a circuit board 4. The left and right sides of case 101 and case 102 are semi-elliptical surfaces, the lens 2 is provided inside case 101 and case 102 and near the semi-elliptical surface of that side of case 101 and case 102, and the edges of the reflector 3 and circuit board 4 are provided in a rounded shape so that they fit the semi-elliptical surface of case 101 and case 102.

The lens 2 is provided with a rotatable tuning ring 5 for rotatably tuning the focal length of the lens 2. A sliding cover 6 is provided in front of the lens 2 for controlling on/off of the projector, and the projector prompts the user to turn on the Bluetooth audio mode when the sliding cover 6 is not opened after the projector is electrically connected. With this design, the audio mode and the projector mode can be switched with one key by sliding the sliding cover 6 left and right, and the operation is made more portable by voice prompts, which can be achieved by prior art and will not be described in the text.

A knob 7 for tuning the volume is provided on the front of the projector, and the knob 7 is provided at a position symmetrical to the lens 2. The knob 7 side is further provided with a headphone jack 8, a USB outlet 9, and a VGA connector 10, and the USB outlet 9 can be connected to a mobile phone to charge the mobile phone. A heat sink 11 is further provided on the back of the projector, an encoder is provided in front of the heat sink to drive the heat sink to dissipate heat (not shown in the figure). A button 12 is provided on the top side of the projector for interaction, a toggle 13 is further provided on the back of the projector for tuning the screen square, which can be achieved by prior art and will not be described in the text.

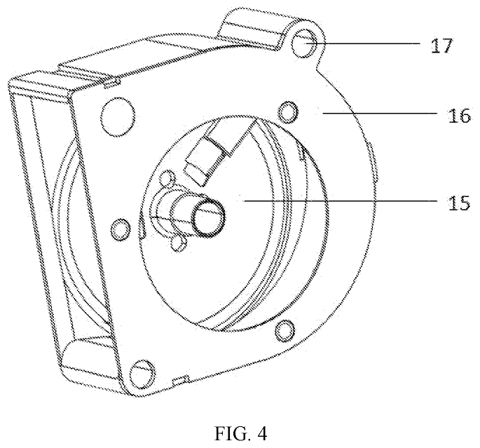

Referring to FIGS. 1 and 4, an audio assembly 14 is provided in the semi-elliptical surfaces on both sides of case 101 and case 102, the audio assembly 14 comprises a full-range speaker 15 and a sound chamber 16, the full-range speaker 15 is mounted in the sound chamber 16, and an air duct 17 is provided on the inner side wall of the sound chamber 16 to allow air to circulate back and forth between the inside and outside of the sound chamber 16 to achieve high fidelity. The audio assembly 14 is designed to allow this projector to produce left and right stereo/surround sound to enhance the user experience.

The above are only the preferred embodiments of the disclosure, and do not limit the scope of the disclosure. Under the inventive concept of the disclosure, any equivalent structure transformation, made by using contents of the description and drawings of the disclosure or applied to other relevant technical fields directly or indirectly, shall be regarded as falling into the scope of patent protection of the disclosure.

1. A portable projector with Bluetooth audio and mobile phone charging functions, wherein it comprises a case, a lens mounted in the case, a reflector and a circuit board, the left and right sides of the case are semi-elliptical surfaces, the lens is provided inside the case and near the semi-elliptical surface of that side of the case, and the edges of the reflector and circuit board are provided in a rounded shape so that they fit the semi-elliptical surface of the case.

2. The portable projector with Bluetooth audio and mobile phone charging functions according to claim 1, wherein a sliding cover is provided in front of the lens for controlling on/off of the projector, and the projector prompts the user to turn on the Bluetooth audio mode when the sliding cover is not opened after the projector is electrically connected.

3. The portable projector with Bluetooth audio and mobile phone charging functions according to claim 2, wherein an audio assembly is mounted within the semi-elliptical surface on both sides of the case.

4. The portable projector with Bluetooth audio and mobile phone charging functions according to claim 3, wherein the audio assembly comprises a full-range speaker and a sound chamber, the full-range speaker is mounted in the sound chamber, and the sound chamber is provided with an air duct on the inner side wall to allow air to circulate back and forth between the inside and outside of the sound chamber to achieve high fidelity.

5. The portable projector with Bluetooth audio and mobile phone charging functions according to claim 4, wherein the lens is provided with a rotatable tuning ring for rotatably tuning the focal length of the lens.

6. The portable projector with Bluetooth audio and mobile phone charging functions according to claim 5, wherein a knob for tuning the volume is provided on the front of the projector, and the knob is provided at a position symmetrical to the lens.

7. The portable projector with Bluetooth audio and mobile phone charging functions according to claim 6, wherein the knob side is further provided with a headphone jack, a USB outlet, and a VGA connector, and the USB outlet can be connected to a mobile phone to charge the mobile phone.

8. The portable projector with Bluetooth audio and mobile phone charging functions according to claim 7, wherein a heat sink is further provided on the back of the projector.

9. The portable projector with Bluetooth audio and mobile phone charging functions according to claim 8, wherein an encoder is provided in front of the heat sink.

10. The portable projector with Bluetooth audio and mobile phone charging functions according to claim 1, wherein a toggle is further provided on the back of the projector for tuning the screen square.
